(19) United States
(12) Patent Application Publication
(10) Pub. No.: US 2005/0235669 A1
(43) Pub. Date: Oct. 27, 2005

(54) Refrigerator and controlling method thereof

(75) Inventor: Sung-ho Cho, Kwangju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/029,725

(22) Filed: Jan. 6, 2005

(30) Foreign Application Priority Data
Apr. 24, 2004 (KR) 2004-0028522

(51) Int. Cl. G05D 23/32; F25D 17/04; F25B 1/00; F25B 49/00

(52) U.S. Cl. 62/229; 62/158

(57) ABSTRACT

A refrigerator comprising a main body having at least one storage compartment, and a refrigerating device including a compressor and an evaporating pipe for refrigerating the storage compartment. The refrigerator has a temperature sensor housed in the storage compartment sensing the temperature of the storage compartment; and a controller which turns on the compressor when the temperature sensed by the temperature sensor reaches a first reference temperature, and turns off the compressor when the temperature sensed by the temperature sensor reaches a second reference temperature that is not higher than the first reference temperature. The controller also turns off the compressor in the case where the temperature sensed by the temperature sensor is not higher than the first reference temperature when a predetermined accumulated time has elapsed after the temperature sensed by the temperature sensor reaches the first reference temperature and the compressor is turned on

### CROSS-REFERENCE TO RELATED APPLICATIONS

This application claims the benefit of Korean Patent Application No. 2004-0028522, filed on Apr. 24, 2004, in the Korean Intellectual Property Office, the disclosure of which is incorporated herein by reference.

### BACKGROUND OF THE INVENTION

1. Field of the Invention

The present invention relates to a refrigerator and a controlling method thereof, and more particularly, to a refrigerator and a controlling method thereof, which provides improved precision in adjusting the temperature of a storage compartment of the refrigerator.

2. Description of the Related Art

Generally, a refrigerator comprises a main body having a storage compartment for storing articles such as food therein, a door opening and closing an opening formed in the storage compartment of the main body, and a refrigerating device for refrigerating the storage compartment of the main body.

Such a refrigerating device comprises a compressor which compresses a gaseous refrigerant to a high-temperature, high-pressure state; a condenser which condenses the compressed refrigerant to a liquid state; a capillary pipe which changes the condensed refrigerant to a low-temperature, low-pressure state; and an evaporating pipe which evaporates the low-temperature and low-pressure condensed refrigerant by absorbing latent heat of evaporation, to thereby refrigerate ambient air. Thus, ambient air contacting the evaporating pipe is cooled, thereby refrigerating the storage compartment.

The refrigerating device can be employed in various heat exchangers such as an air conditioner as well as a refrigerator.

Further, the refrigerating device can be classified into an indirect cooling type in which cold generated by the evaporating pipe is supplied to the storage compartment to cool the inside of the storage compartment, and a direct cooling type in which the evaporating pipe is attached to the outside of the storage compartment.

The direct cooling type refrigerating device can adjust the temperature of the storage compartment more precisely than the indirect cooling system, and thus has been widely used in a Kimchi refrigerator, etc., for storing Kimchi or the like having a taste sensitively which varies according to temperature.

Hereinafter, the direct cooling type refrigerator will be described by way of example.

A conventional refrigerator comprises a reservoir to store Kimchi or the like therein, a main body having a storage compartment to accommodate the reservoir therein, a door opening and closing an opening formed in the storage compartment of the main body, and a refrigerating device provided in the main body and refrigerating the storage compartment. Further, a conventional refrigerator comprises a controller which controls the refrigerating device to adjust the temperature of the storage compartment.

The controller turns the compressor on when the temperature t of the storage compartment reaches an upper limit temperature t1 and turns the compressor off when the temperature t of the storage compartment reaches a lower limit temperature t2 (referring to FIG. 1). Thus, in a conventional refrigerator, the controller can adjust the temperature t of the storage compartment.

However, in a conventional refrigerator, the controller controls the compressor to start and stop operating at the upper limit temperature t1 and the lower limit temperature t2, respectively, so that it is difficult to adjust the temperature t of the storage compartment so as to be within a setting temperature range A. That is, in a conventional refrigerator, even though the controller controls the compressor to stop operating at the lower limit temperature t2, the temperature t of the storage compartment is further lowered, by action of the evaporating pipe, as represented by the following cooling adjustment B. Therefore, the temperature t of the storage compartment decreases far beyond the setting temperature range A by the following cooling adjustment B (i.e., the cooling adjustment which follows once the compressor is turned off).

Thus, in a conventional refrigerator, the temperature t of the storage compartment decreases far beyond the setting temperature range A, so that it is difficult to maintain the taste of the food stored in the storage compartment. Further, the storage compartment is unnecessarily undercooled, resulting in power loss.

### SUMMARY OF THE INVENTION

Accordingly, an object of the present invention is to provide a refrigerator and a controlling method thereof, in which the temperature of a storage compartment is more precisely adjusted and power is conserved.

The foregoing and/or other objects of the present invention are achieved by providing a refrigerator comprising a main body having at least one storage compartment, and a refrigerating device comprising a compressor and an evaporating pipe for refrigerating the storage compartment, the refrigerator comprising at least one temperature sensor provided in the storage compartment for sensing the temperature of the storage compartment; and a controller controlling the compressor to start operating when the temperature sensed by the temperature sensor reaches a first reference temperature and to stop operating when the temperature sensed by the temperature sensor reaches a second reference temperature not higher than the first reference temperature, the controller controlling the compressor to stop operating in the case where the temperature sensed by the temperature sensor is not higher than the first reference temperature when a predetermined accumulated time X1 has elapsed after the temperature sensed by the temperature sensor reaches the first reference temperature and the compressor starts operating.

According to another embodiment of the present invention, the controller controls the compressor to stop operating regardless of the accumulated time X1 when the temperature sensed by the temperature sensor reaches the second reference temperature in the case where the temperature sensed by the temperature sensor reaches a third reference temperature higher than the first reference temperature.

According to yet another embodiment of the present invention, the refrigerating device comprises a switching valve permitting and obstructing refrigerant flow toward the evaporating pipe, the controller opening the switching valve prior to a predetermined delay time X2 before the compressor starts operating, and closing the switching valve following a predetermined delay time X3 after the compressor stops operating.

According to yet another embodiment of the present invention, the temperature sensor is spaced from a wall of the storage compartment and the evaporating pipe so as to sense air temperature inside the storage compartment.

According to yet another embodiment of the present invention, the wall of the storage compartment comprises a sensor accommodating portion protruding outwardly and accommodating the temperature sensor therein.

According to yet another embodiment of the present invention, the refrigerating device is a direct cooling type refrigerating device, wherein the evaporating pipe is attached to the outside of the storage compartment.

The foregoing and/or other objects of the present invention are also achieved by providing a method of controlling a refrigerator comprising a main body having at least one storage compartment, and a refrigerating device comprising a compressor and an evaporating pipe for refrigerating the storage compartment, and at least one temperature sensor mounted to the storage compartment for sensing the temperature of the storage compartment, the method comprising: controlling the compressor to start operating when the temperature sensed by the temperature sensor reaches a first reference temperature; controlling the compressor to stop operating when the temperature sensed by the temperature sensor reaches a second reference temperature not higher than the first reference temperature; and controlling the compressor to stop operating in the case where the temperature sensed by the temperature sensor is not higher than the first reference temperature when a predetermined accumulated time X1 has elapsed after the temperature sensed by the temperature sensor reaches the first reference temperature and the compressor starts operating.

According to another embodiment of the present invention, the method further comprising controlling the compressor to stop operating regardless of the accumulated time X1 when the temperature sensed by the temperature sensor reaches the second reference temperature in the case where the temperature sensed by the temperature sensor reaches a third reference temperature higher than the first reference temperature.

According to yet another embodiment of the present invention, the refrigerator device comprises a switching valve permitting and obstructing refrigerant flow toward the evaporating pipe, the method further comprising: opening the switching valve prior to a predetermined delay time X2 before controlling the compressor to start operating, and closing the switching valve following a predetermined delay time X3 after controlling the compressor to stop operating.

### BRIEF DESCRIPTION OF THE DRAWINGS

The above and/or other aspects and advantages of the present invention will become apparent from the following description of the embodiments, taken in conjunction with the accompanying drawings of which:

FIG. 1 is a graph showing a temperature adjustment in a storage compartment of a conventional refrigerator;

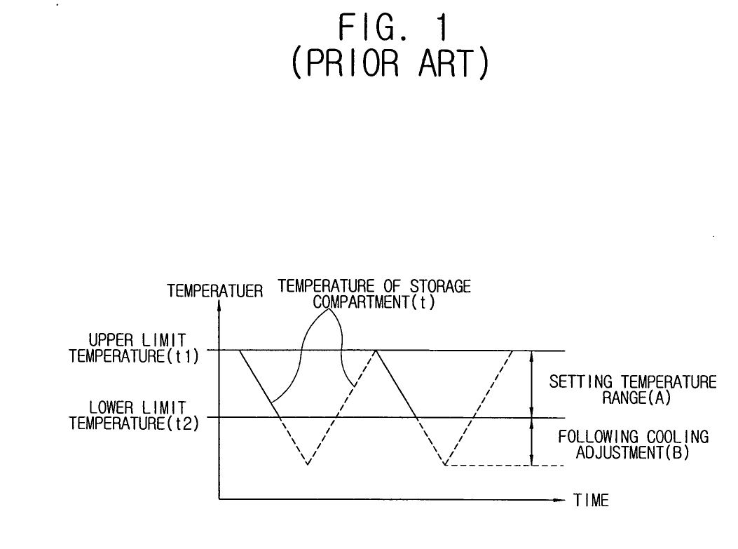

FIG. 2 is a sectional view of a refrigerator according to an embodiment of the present invention;

FIG. 3 is a partially enlarged sectional view of a temperature sensor in the refrigerator of FIG. 2;

FIG. 4 is a schematic control block diagram of the refrigerator according to an embodiment of the present invention;

FIG. 5 is a graph showing temperature adjustment in a storage compartment of the refrigerator according to an embodiment of the present invention;

FIG. 6 is a graph showing control of a compressor and a switching valve of the refrigerator according to an embodiment of the present invention; and

FIG. 7 is a control flowchart of the refrigerator according to an embodiment of the present invention.

### DETAILED DESCRIPTION OF THE PREFERRED EMBODIMENTS

The invention will now be described in greater detail by reference to the accompanying drawings, in which like reference numerals refer to like elements throughout. However, the present invention should not be construed as being limited thereto.

A refrigerating device for use in a refrigerator according to an embodiment of the present invention can be an indirect cooling type refrigerating device in which cold generated by the evaporating pipe is supplied to the storage compartment to cool the inside of the storage compartment, and a direct cooling type in which the evaporating pipe is attached to the outside of the storage compartment. Hereinafter, a direct cooling type Kimchi refrigerator will be described by way of example with reference to the accompanying drawings.

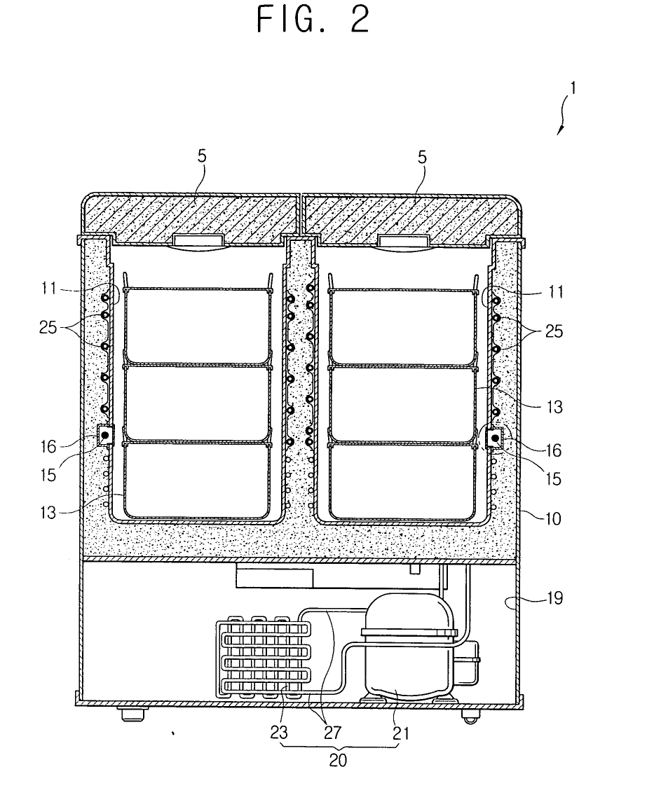

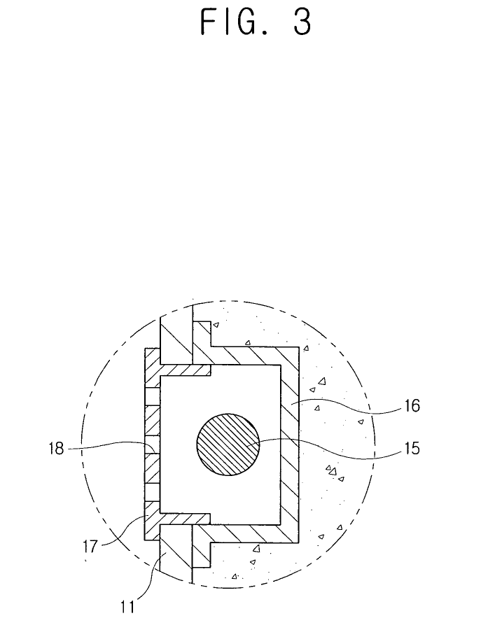

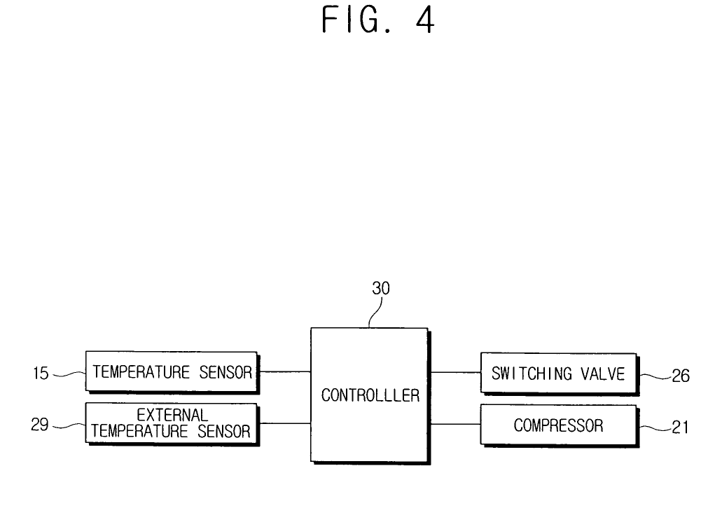

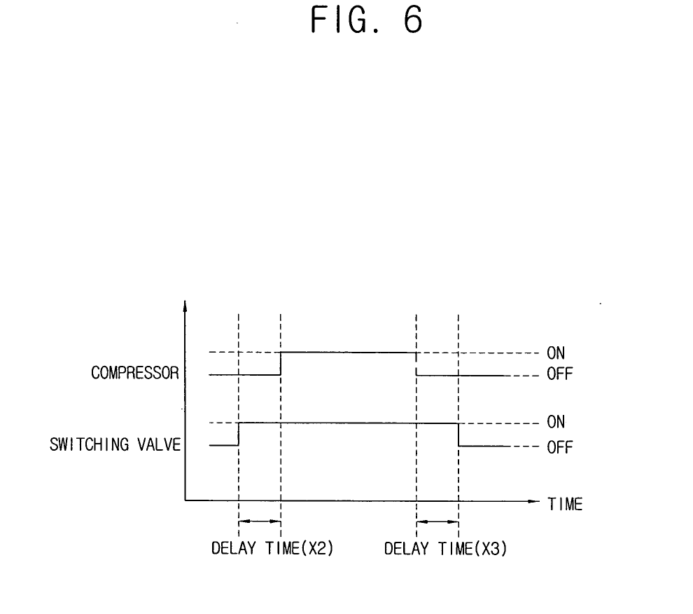

As shown in FIGS. 2 through 6, a refrigerator 1 according to an embodiment of the present invention comprises a main body 10 having at least one storage compartment 11; a door 5 coupled to the main body 10 and opening/closing an opening formed in the storage compartment 11; a refrigerating device 20 comprising a compressor 21 and an evaporating pipe 25 for refrigerating the storage compartment 11; at least one temperature sensor 15 provided in the storage compartment 11 for sensing the temperature of the storage compartment; a controller 30 controlling the compressor 21 to start operating when the temperature t sensed by the temperature sensor 15 reaches a first reference temperature t1 and to stop operating when the temperature t sensed by the temperature sensor 15 reaches a second reference temperature t2 not higher than the first reference temperature t1 (generally, t2 is lower than t1).

The main body 10 comprises a pair of storage compartments 11 accommodating at least one reservoir 13, and a component compartment 19 accommodating compressor 21 or the like of the refrigerating device 20.

The refrigerating device 20 comprises the compressor 21 which compresses a gaseous refrigerant to a high-temperature, high-pressure state; a condenser 23 which condenses the compressed refrigerant to a liquid state; a capillary pipe (not shown) which changes the condensed refrigerant to a low-temperature, low-pressure state; an evaporating pipe 25 which evaporates the low-temperature and low-pressure condensed refrigerant by absorbing latent heat of evaporation to refrigerate ambient air and thus refrigerate the storage compartment 11; and a refrigerant pipe 27 connecting the compressor 21, the evaporating pipe 25 and the like and allowing the refrigerant to circulate therebetween. Further, the refrigerating device 20 comprises a switching valve 26 for permitting and obstructing refrigerant flow toward the evaporating pipe 25.

The switching valve 26 is preferably provided in a refrigerant pipe 27 between the condenser 23 and the evaporating pipe 25, and controlled by the controller 30 to open and close the refrigerant pipe 27. Further, the switching valve 26 is more preferably provided between the refrigerant pipe 27 connecting the condenser 23 and the capillary pipe. However, in the case where the refrigerating device 20 employs an expansion valve (not shown) instead of a capillary pipe (not shown) for expanding the refrigerant, the switching valve 26 may be provided in the refrigerant pipe 27 between the condenser 23 and the expansion valve and controlled by the controller 30 to open and close the refrigerant pipe 27, or the switching valve 26 may be integrated with the expansion valve. That is, in the case where the switching valve 26 and the expansion valve are integrated as a single body, the switching valve 26 can permit/obstruct refrigerant flow and can also expand the refrigerant. Further, the switching valve 26 is preferably arranged between the condenser 23 and the capillary pipe or between the condenser 23 and the expansion valve, but may also be arranged between the capillary pipe or the evaporating pipe 25 or between the expansion valve and the evaporating pipe 25.

The temperature sensor 15 is preferably spaced from a wall of the storage compartment 11 and the evaporating pipe 25 to sense air temperature inside the storage compartment 11. Further, the temperature sensor 15 is preferably accommodated in a sensor accommodating portion 16 provided in the storage compartment 11. Here, information about the temperature sensed by the temperature sensor 15 is transmitted to the controller 30, and the controller 30 adjusts the temperature of the storage compartment 11 based on the sensed temperature. Thus, the temperature sensor 15 is suitably placed so as to sense the air temperature inside the storage compartment 11 (as opposed to sensing the temperature of the wall of the storage compartment 11 or the evaporating pipe 25). In this manner the temperature sensor 15 can sense the internal temperature of the storage compartment 11 more precisely than by estimating the internal temperature of the storage compartment based on the temperature of the wall of the storage compartment 11 or the evaporating pipe 25. However, the temperature sensor 15 may be disposed so as to sense the temperature of the wall of the storage compartment 11 or the evaporating pipe 25.

Preferably, the sensor accommodating portion 16 is formed in the wall of the storage compartment 11 and protrudes outwardly to accommodate the temperature sensor 15 therein. Further, the sensor accommodating portion 16 is preferably covered with a sensor cover 17.

The sensor cover 17 covers an opening of the sensor accommodating portion 16 accommodating the temperature sensor 15 therein. Further, the sensor cover 17 has a plurality of through holes 18 communicating with the inside of the storage compartment 11, thereby allowing air to freely contact the temperature sensor 15.

Preferably, the controller 30 turns off compressor 21 when the temperature t sensed by the temperature sensor 15 falls below a first reference temperature t1 after lapse of a predetermined accumulated time X1 beginning from the time when the temperature t sensed by temperature sensor 15 reaches the first reference temperature and compressor 21 is thus turned on. Further, the controller 30 is set within a setting temperature range A of the storage compartment 11 to be set by the manufacturer or user. Here, the setting temperature range A includes the first reference temperature t1 and the second reference temperature t2, which are employed as reference temperatures of the storage compartment to be controlled by the controller 30. That is, the first reference temperature t1 is an upper limit temperature of the setting temperature range A, and the second reference temperature t2 is a lower limit of the setting temperature range A. For example, the setting temperature range A may range from −0.5° C. to −1.5° C. The setting temperature range A may be set according to the kind of refrigerating device, external temperature, etc. Additionally, the refrigerator according to an embodiment of the present invention preferably comprises an external temperature sensor 29 provided in the main body 10 for sensing the external temperature.

Further, the controller 30 is set with a third reference temperature t3 higher than the first reference temperature t1. When the temperature t sensed by the temperature sensor 15 reaches the third temperature t3, the controller 30 turns off compressor 21 regardless of the accumulated time X1 when the temperature t sensed by the temperature sensor 15 reaches the second reference temperature t2.

Further, the controller 30 opens switching valve 26 for a predetermined delay time X2 prior to turning on compressor 21, and closes switching valve 26 following a predetermined delay time X3 after turning off compressor 21. Here, the delay times X2 and X3 preferably range from dozens of seconds to a few minutes, e.g., from 10 seconds to 10 minutes, but may be dozens of minutes, e.g., 20˜30 minutes. Further, the delay times X2 and X3 are preferably different from one another. During the delay time X2 (from the time that switching valve 26 is opened to the time that compressor 21 is turned on), the pressure of the refrigerant supplied to the evaporating pipe 25, the condenser 23, etc., of the refrigerating device 20 is approximately equilibrated before compressor 21 is turned on, so that the compressor 21 operates smoothly. Further, during the delay time X3 (from the time that compressor 21 is turned off to the time that switching valve 26 is closed), the pressure of the refrigerant supplied to the evaporating pipe 25, the condenser 23, etc., of the refrigerating device 20 is approximately equilibrated before switching valve 26 is closed.

The accumulated time X1 is a predetermined period of time that has passed once the temperature t sensed by the temperature sensor 15 reaches the first reference temperature t1 and the compressor 21 is turned on. Preferably, the accumulated time X1 is about 2 minutes. However, the accumulated time X1 may be variously set according to the external temperature, capacity or construction of the refrigerating device 20 and the storage compartment, etc., for example, equal to or less than 1 minute, or equal to or over than 3 minutes. Thus, in the case where the elapsed time after turning on compressor 21 is larger than the accumulated time X1 and the temperature t sensed by the temperature sensor 15 is equal to or lower than the first reference temperature t1, the controller 30 closes switching valve 26 and turns off compressor 21 even though the temperature t sensed by the temperature sensor 15 has not yet reached the second reference temperature t2. The air temperature inside the storage compartment 11 will then continue to decrease due to free convection by the evaporating pipe 25 during a following cooling adjustment B, and therefore approaches the second reference temperature t2. Thereafter, the temperature of the storage compartment increases again due to the external temperature or the like. Thus, in the case where the time elapsed after compressor 21 is turned on is larger than the accumulated time X1, the controller 30 turns off the compressor 21 when the temperature t sensed by the temperature sensor 15 is not higher than the first reference temperature t1 and has not yet reached the second reference temperature t2, thereby allowing the temperature of the storage compartment 11 to be more precisely adjusted within the setting temperature range. Additionally, the temperature t of the temperature sensor 15 does not decrease much below the second reference temperature t2, thereby preventing unnecessary and excessive cooling and increasing operating efficiency.

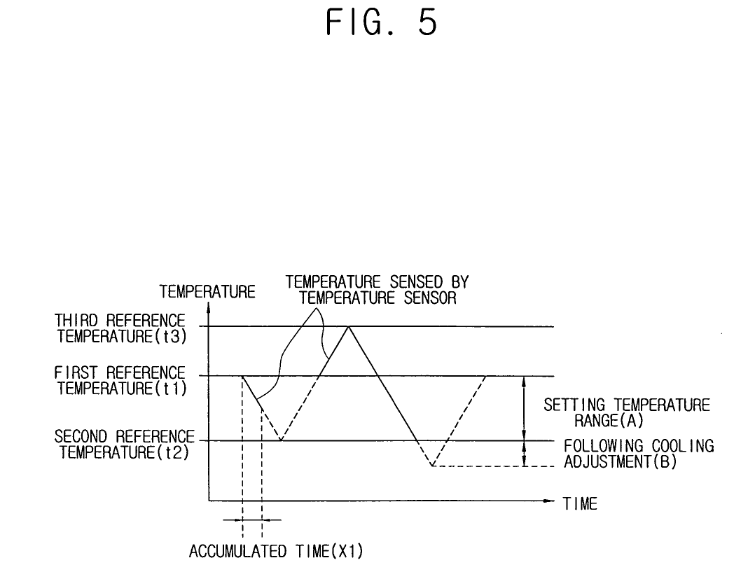

Further, the third reference temperature t3 is preferably set higher than the first reference temperature t1. For example, the third reference temperature t3 is set higher than the first reference temperature t1 by about 5° C. That is, in the case where the first reference temperature t1 is −0.5° C., the third reference temperature t3 is preferably 4.5° C. However, the third reference temperature t3 may be variously set, e.g., may be equal to or less than 4° C., or may be equal to or over than 6° C. Meanwhile, the temperature of the storage compartment 11 may increase beyond the third reference temperature t3 when the load is increased, for example, when food is newly accommodated in the storage compartment 11. In this case, the compressor remains on until the temperature t sensed by the temperature sensor 15 reaches the second reference temperature t2 regardless of the accumulated time X1, at which time the controller 30 turns off compressor 21. Thus, the load such as food newly accommodated in the storage compartment 11 is relatively rapidly cooled, thereby keeping the food or the like fresh. For reference, in FIG. 5, the solid line indicates the temperature t while the compressor 21 is on, and the dotted line indicates the temperature t while the compressor 21 is off.

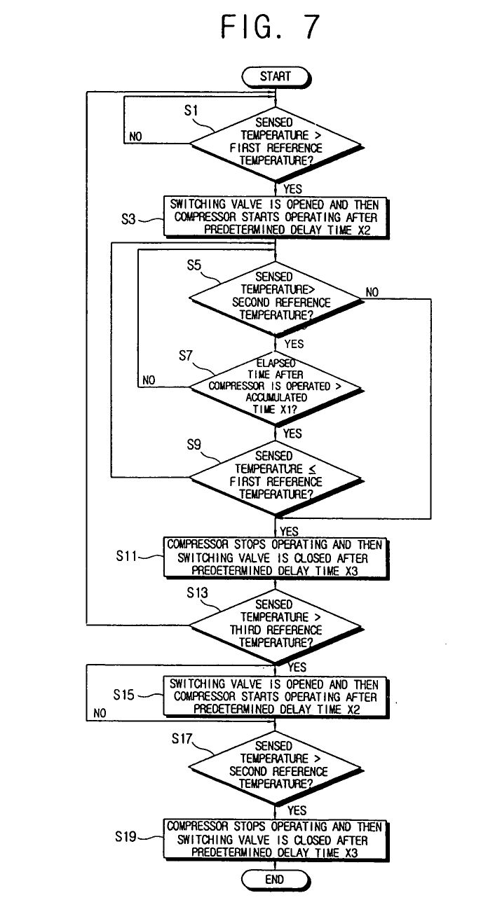

With this configuration, the temperature adjustment in the storage compartment of the refrigerator according to an embodiment of the present invention will be described with reference to FIG. 7.

First, at operation S1, controller 30 receives information about the temperature t sensed by the temperature sensor 15 provided in the storage compartment 11, and compares the sensed temperature t with the first limit temperature t1. In the case where the temperature t sensed by the temperature sensor 11 is higher than the first reference temperature t1, at operation S3, the switching valve 26 is opened and then the compressor 21 is turned on when the delay time X2, determined from the time that the switching valve 26 is opened, has elapsed. Then, at operation S5, the temperature t sensed by the temperature sensor 15 is compared with the second reference temperature t2. In the case where the temperature t sensed by the temperature sensor 15 is lower than or equal to the second reference temperature t2, at operation S11, the compressor 21 is turned off and then the switching valve 26 is closed when the delay time X3, determined from the time that the compressor 21 is turned off, has elapsed. On the other hand, in the case where the temperature t sensed by the temperature sensor 15 is higher than the second reference temperature t2, at operation S7, the time that has elapsed after the compressor 21 is turned on is compared with the accumulated time X1. In the case where the time elapsed after the compressor 21 is turned on is less than or equal to the accumulated time X1, at operation S5, the temperature t sensed by the temperature sensor 15 is compared again with the second reference temperature t2. In the case where the time that has elapsed after the compressor 21 is turned on is larger than the accumulated time X1, at operation S9, the temperature t sensed by the temperature sensor 15 is compared with the first reference temperature t1. At this time, in the case where the temperature t sensed by the temperature sensor 15 is higher than the first reference temperature t1, at operation S5, the temperature t sensed by the temperature sensor 15 is compared again with the second reference temperature t2. Then, in the case where the temperature t sensed by the temperature sensor 15 is lower than or equal to the first reference temperature t1, at operation S11, the compressor 21 is turned off and then the switching valve 26 is closed when the delay time X3, determined from the time that the compressor 21 is turned off, has elapsed. Thus, in the case where the time that has elapsed after compressor 21 is turned on is larger than the accumulated time X1, the controller 30 turns off compressor 21 in the state that the temperature t sensed by the temperature sensor 15 is not higher than the first reference temperature t1 and has not yet reached the second reference temperature t2. This control scheme of the present invention allows the temperature of the storage compartment 11 to be more precisely adjusted within the setting temperature range. Additionally, the temperature t of the temperature sensor 15 does not decrease much below the second reference temperature t2, thereby preventing unnecessary and excessive cooling and promoting operating efficiency.

Thereafter, the temperature of the storage compartment 11 increases in a state in which the compressor 21 is turned off and the switching valve 26 is closed. Then, at operation S13, the temperature t sensed by the temperature sensor 15 is compared with the third reference temperature t3 when a predetermined time has elapsed after the compressor 21 is turned off. At this time, the elapsed time can be variously set according to the external temperature or the properties of the refrigerating device 20. In the case where the temperature t sensed by the temperature sensor 15 is not higher than the third reference temperature t3, the temperature adjustment is returned to operation S1 which compares the temperature t sensed by the temperature sensor 15 with the first reference temperature t1. On the other hand, in the case where the temperature t sensed by the temperature sensor 15 is higher than or equal to the third reference temperature t3, at operation S15, the switching valve 26 is opened and then the compressor 21 is turned on when the delay time X3 has elapsed after the switching valve 26 is opened. After the switching valve 26 is opened and the compressor 21 is turned on, at operation S17, the temperature t sensed by the temperature sensor 15 is compared with the second reference temperature t2. At this time, in the case where the temperature t sensed by the temperature sensor 15 is higher than the second reference temperature t2, at operation S17, the temperature t sensed by the temperature sensor 15 is compared again with the second reference temperature t2. Then, in the case where the temperature t sensed by the temperature sensor 15 is lower than or equal to the second reference temperature t2, at operation S19, the compressor 21 is turned off and then the switching valve 26 is closed after the delay time X3 has elapsed (measured from the time that the compressor 21 is turned off). Thus, when the temperature t sensed by the temperature sensor 15 increases above the third reference temperature t3, the controller 30 controls the compressor 21 to continuously operate regardless of the accumulated time X1 until the temperature t sensed by the temperature sensor 15 reaches the second reference temperature t2. Thus, a load such as food newly accommodated in the storage compartment 11 is relatively rapidly cooled, thereby keeping the food or the like fresh.

Thus, the refrigerator according to an embodiment of the present invention comprises a controller which controls the compressor to start operating when the temperature sensed by the temperature sensor reaches the first reference temperature; to stop operating when the temperature sensed by the temperature sensor reaches the second reference temperature not higher than the first reference temperature; and to stop operating when the temperature sensed by the temperature sensor is equal to or less than the first reference temperature when a predetermined accumulated time X1 has elapsed after the temperature sensed by the temperature sensor reaches the first reference temperature and the compressor starts operating. Consequently, the temperature of the storage compartment is more precisely adjusted, thereby preventing unnecessary and excessive cooling operation, and promoting efficient operation.

Further, the refrigerator according to an embodiment of the present invention comprises a controller which is set with a third reference temperature higher than the first reference temperature, and controls the compressor to stop operating regardless of the accumulated time X1 when the temperature sensed by the temperature sensor reaches the second reference temperature in the case where the temperature sensed by the temperature sensor reaches the third reference temperature. Consequently, food or the like newly accommodated in the storage compartment is fully cooled, thereby keeping the food or the like fresh.

As described above, the present invention provides a refrigerator and a controlling method thereof, which allows the temperature of a storage compartment to be more precisely adjusted and which promotes operating efficiently.

Although certain embodiments of the present invention have been shown and described, it will be appreciated by those skilled in the art that changes may be made in these embodiments without departing from the principles and spirit of the invention, the scope of which is defined in the appended claims and equivalents thereof.

1. A refrigerator comprising a main body having at least one storage compartment, and a refrigerating device comprising a compressor and an evaporating pipe for refrigerating the storage compartment, the refrigerator comprising:
at least one temperature sensor provided in the storage compartment for sensing the temperature of the storage compartment; and
a controller controlling the compressor to start operating when the temperature sensed by the temperature sensor reaches a first reference temperature and to stop operating when the temperature sensed by the temperature sensor reaches a second reference temperature not higher than the first reference temperature,
the controller controlling the compressor to stop operating in the case where the temperature sensed by the temperature sensor is not higher than the first reference temperature when a predetermined accumulated time X1 has elapsed after the temperature sensed by the temperature sensor reaches the first reference temperature and the compressor starts operating.

2. The refrigerator as claimed in claim 1, wherein the controller controls the compressor to stop operating regardless of the accumulated time X1 when the temperature sensed by the temperature sensor reaches the second reference temperature in the case where the temperature sensed by the temperature sensor reaches a third reference temperature higher than the first reference temperature.

3. The refrigerator as claimed in claim 1, wherein the refrigerating device comprises a switching valve permitting and obstructing refrigerant flow toward the evaporating pipe,
the controller opening the switching valve prior to a predetermined delay time X2 before the compressor starts operating, and closing the switching valve following a predetermined delay time X3 after the compressor stops operating.

4. The refrigerator as claimed in claim 1, wherein the temperature sensor is spaced from a wall of the storage compartment and the evaporating pipe so as to sense air temperature inside the storage compartment.

5. The refrigerator as claimed in claim 4, wherein the wall of the storage compartment comprises a sensor accommodating portion protruding outwardly and accommodating the temperature sensor therein.

6. The refrigerator as claimed in claim 1, wherein the evaporating pipe is attached to the outside of the storage compartment.

7. A method of controlling a refrigerator comprising a main body having at least one storage compartment, a refrigerating device comprising a compressor and an evaporating pipe for refrigerating the storage compartment, and at least one temperature sensor mounted to the storage compartment for sensing the temperature of the storage compartment, the method comprising:
controlling the compressor to start operating when the temperature sensed by the temperature sensor reaches a first reference temperature;
controlling the compressor to stop operating when the temperature sensed by the temperature sensor reaches a second reference temperature not higher than the first reference temperature; and
controlling the compressor to stop operating in the case where the temperature sensed by the temperature sensor is not higher than the first reference temperature when a predetermined accumulated time X1 has elapsed after the temperature sensed by the temperature sensor reaches the first reference temperature and the compressor starts operating.

8. The method as claimed in claim 7, which further comprises:
controlling the compressor to stop operating regardless of the accumulated time X1 when the temperature sensed by the temperature sensor reaches the second reference temperature in the case where the temperature sensed by the temperature sensor reaches a third reference temperature higher than the first reference temperature.

9. The method as claimed in claim 7,
wherein said refrigerator device comprises a switching valve permitting and obstructing refrigerant flow toward the evaporating pipe, said method further comprising:
opening the switching valve prior to a predetermined delay time X2 before controlling the compressor to start operating, and closing the switching valve following a predetermined delay time X3 after controlling the compressor to stop operating.
